(19) United States
(12) Patent Application Publication
(10) Pub. No.: US 2023/0037312 A1
(43) Pub. Date: Feb. 9, 2023

(54) FORWARD MONITORING APPARATUS, TRAIN CONTROL SYSTEM, AND FORWARD MONITORING METHOD

(71) Applicant: Mitsubishi Electric Corporation, Chiyoda-ku, Tokyo (JP)

(72) Inventors: Masashi TOMIDA, Tokyo (JP); Yukitoshi INABA, Tokyo (JP); Koki YOSHIMOTO, Tokyo (JP)

(73) Assignee: Mitsubishi Electric Corporation, Chiyoda-ku, Tokyo (JP)

(21) Appl. No.: 17/793,099

(22) PCT Filed: Jan. 23, 2020
(86) PCT No.: PCT/JP2020/002265

§ 371 Date: Jul. 15, 2022

(51) Int. Cl. B61L 25/02; B61L 27/10

(52) U.S. Cl. CPC B61L 25/02; B61L 27/10

(57) ABSTRACT

A forward monitoring apparatus is installed on a train, and includes: a monitoring unit that monitors a situation ahead of the train; a storage unit that stores map information including information on a position of a track, a shape of the track, and a position of a turnout provided on the track; a train position acquisition unit that acquires train position information indicating a position of the train; a route information acquisition unit that acquires open route information including information for indicating an open direction of the turnout located ahead of the train; and a monitoring direction determination unit that determines a direction to be monitored by the monitoring unit, by using the open route information acquired, the train position information acquired, and the map information being stored in the storage unit.

### FIELD

The present disclosure relates to a forward monitoring apparatus that monitors a situation ahead of a train, a train control system, and a forward monitoring method.

### BACKGROUND

Conventionally, there has been known a forward monitoring apparatus that monitors a situation ahead of a train by means of a sensor such as a camera installed on the train, and detects an obstacle on the route of the train (see, for example, Patent Literature 1). Patent Literature 1 discloses that in a case where, for example, there is a turnout on a track of a train, information on a traveling direction of the train flows from an ATC loop located before the turnout, and is input via an ATC on-board antenna to the forward monitoring apparatus, so that the forward monitoring apparatus recognizes the traveling direction of the train at the turnout, and changes its own direction on the basis of the traveling direction.

### CITATION LIST

### Patent Literature

Patent Literature 1: Japanese Patent Application Laid-open No. 2019-004587

### SUMMARY

### Technical Problem

However, since the information on the traveling direction of the train is acquired from the ATC loop, the traveling direction cannot be recognized in the forward monitoring apparatus of Patent Literature 1 until the train arrives at a point located before the turnout. Therefore, in the case of the technique disclosed in Patent Literature 1, it is difficult to perform processing of appropriately switching the forward monitoring apparatus to a direction to be monitored on a track on which a plurality of turnouts is consecutively provided.

The present disclosure has been made to solve a problem as described above, and an object of the present disclosure is to provide a forward monitoring apparatus, a train control system, and a forward monitoring method that enable appropriate recognition of a traveling direction in which a train should go after passing through a turnout, so that a direction to be monitored can be adjusted to the traveling direction of the train even on a track on which a plurality of turnouts is consecutively provided.

### Solution to Problem

In order to achieve the above-described object, a forward monitoring apparatus according to the present disclosure is installed on a train, and includes: a monitoring unit to monitor a situation ahead of the train; a storage unit to store map information including information on a position of a track on which the train travels, a shape of the track, and a position of a turnout provided on the track; a train position acquisition unit to acquire train position information indicating a position of the train; a route information acquisition unit to acquire open route information including information for indicating an open direction of the turnout located ahead of the train; and a monitoring direction determination unit to determine a direction to be monitored by the monitoring unit, by using the open route information, the train position information, and the map information, the open route information being acquired by the route information acquisition unit, the train position information being acquired by the train position acquisition unit, the map information being stored in the storage unit.

Additionally, a forward monitoring apparatus according to the present disclosure is installed on a train, and includes: a monitoring unit to monitor a situation ahead of the train; a storage unit to store map information including information on a position of a track on which the train travels, a shape of the track, and a position of a turnout provided on the track; a train position acquisition unit to acquire train position information indicating a position of the train; a schedule information acquisition unit to acquire schedule information including information on a track number of a track to be used by the train; and a monitoring direction determination unit to determine a direction to be monitored by the monitoring unit, by using the schedule information, the train position information, and the map information, the schedule information being acquired by the schedule information acquisition unit, the train position information being acquired by the train position acquisition unit, the map information being stored in the storage unit.

### Advantageous Effects of Invention

A forward monitoring apparatus according to the present disclosure is installed on a train, and includes: a monitoring unit that monitors a situation ahead of the train; a storage unit that stores map information including information on a position of a track on which the train travels, a shape of the track, and a position of a turnout provided on the track; a train position acquisition unit that acquires train position information indicating a position of the train; a route information acquisition unit that acquires open route information including information for indicating an open direction of the turnout located ahead of the train; and a monitoring direction determination unit that determines a direction to be monitored by the monitoring unit, by using the open route information, the train position information, and the map information, the open route information being acquired by the route information acquisition unit, the train position information being acquired by the train position acquisition unit, the map information being stored in the storage unit. Therefore, it is possible to appropriately recognize a traveling direction in which a train should go after passing through a turnout, and adjust a direction to be monitored to the traveling direction of the train even on a track on which a plurality of turnouts is consecutively provided.

Furthermore, a forward monitoring apparatus according to the present disclosure is installed on a train, and includes: a monitoring unit that monitors a situation ahead of the train; a storage unit that stores map information including information on a position of a track on which the train travels, a shape of the track, and a position of a turnout provided on the track; a train position acquisition unit that acquires train position information indicating a position of the train; a schedule information acquisition unit that acquires schedule information including information on a track number of a track to be used by the train; and a monitoring direction determination unit that determines a direction to be monitored by the monitoring unit, by using the schedule information, the train position information, and the map information, the schedule information being acquired by the schedule information acquisition unit, the train position information being acquired by the train position acquisition unit, the map information being stored in the storage unit. Therefore, it is possible to appropriately recognize a traveling direction in which a train should go after passing through a turnout, and adjust a direction to be monitored to the traveling direction of the train even on a track on which a plurality of turnouts is consecutively provided.

### BRIEF DESCRIPTION OF DRAWINGS

FIG. 1 is a block diagram showing an example of a configuration of a train control system according to a first embodiment of the present disclosure.

FIG. 2 is a diagram showing an example of open route information.

FIG. 3 is a flowchart showing an example of a flow of forward monitoring processing to be performed by a forward monitoring apparatus according to the first embodiment of the present disclosure.

FIG. 4 is a diagram for describing an example of processing to be performed by the forward monitoring apparatus according to the first embodiment of the present disclosure, for determining a direction to be monitored by a monitoring unit.

FIG. 5 is a diagram showing an example in which processing circuitry included in the forward monitoring apparatus according to the first embodiment of the present disclosure includes a processor and a memory.

FIG. 6 is a diagram showing an example in which the processing circuitry included in the forward monitoring apparatus according to the first embodiment of the present disclosure includes dedicated hardware.

FIG. 7 is a diagram for describing another example of the processing to be performed by the forward monitoring apparatus according to the first embodiment of the present disclosure, for determining a direction to be monitored by the monitoring unit.

FIG. 8 is a block diagram showing an example of a configuration of a train control system according to a second embodiment of the present disclosure.

FIG. 9 is a flowchart showing an example of a flow of forward monitoring processing to be performed by a forward monitoring apparatus according to the second embodiment of the present disclosure.

FIG. 10 is a diagram for describing an example of processing to be performed by the forward monitoring apparatus according to the second embodiment of the present disclosure, for determining a direction to be monitored by a monitoring unit.

### DESCRIPTION OF EMBODIMENTS

Hereinafter, embodiments of a train control system including a forward monitoring apparatus according to the present disclosure will be described with reference to the drawings.

### First Embodiment

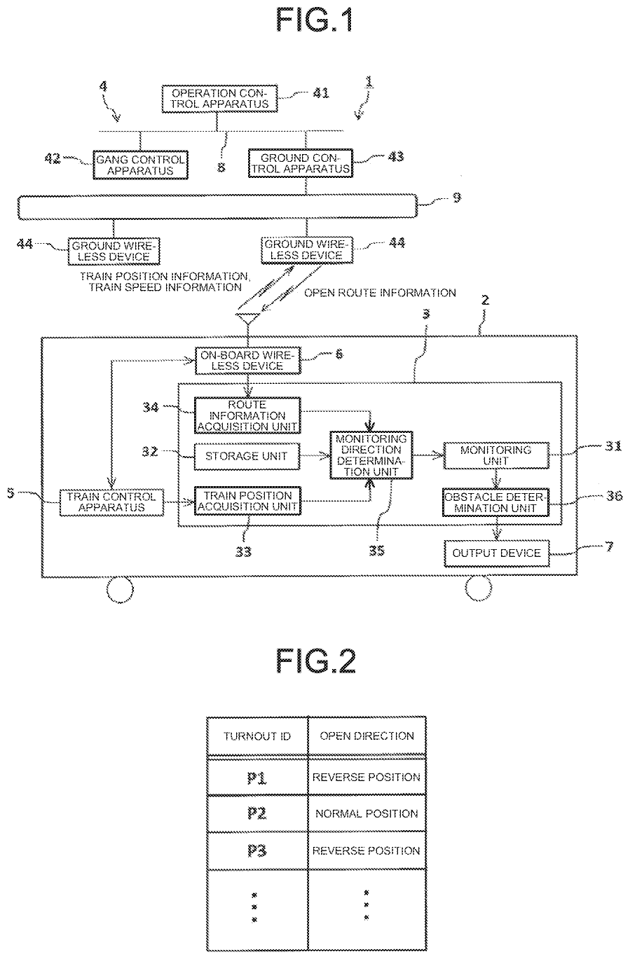

FIG. 1 is a block diagram showing an example of a configuration of a train control system 1 according to the present embodiment, that is, a first embodiment. As illustrated in FIG. 1, the train control system 1 includes, for example, a forward monitoring apparatus 3, an operation control apparatus 41, a gang control apparatus 42, and an operation control system 4. The forward monitoring apparatus 3 is installed on a train 2. The operation control apparatus 41 controls operation of the train 2. The gang control apparatus 42 controls operation of a turnout or the like provided on a track on which the train 2 travels. The operation control system 4 includes a ground control apparatus 43 that performs wireless communication with the train 2.

The forward monitoring apparatus 3 is installed on the train 2, and detects an obstacle in the traveling direction of the train 2. In addition, the forward monitoring apparatus 3 is installed on the train 2 together with a train control apparatus 5, an on-board wireless device 6, and an output device 7, and is communicably connected to the train control apparatus 5, the on-board wireless device 6, and the output device 7.

The train control apparatus 5 detects the current position and speed of the train 2 and a direction of train operation, that is, whether the train 2 is an up train or down train. Although not illustrated in detail, the train control apparatus 5 on the train 2 generates train position information indicating the position of the train 2 by calculating a travel distance from a reference position on the basis of information on the speed of the train 2 detected by a tacho-generator. For example, a position where ground coil information on a ground coil installed on a track on which the train 2 travels is detected by a pickup coil is used as the reference position. The train position information is information such as one-dimensional position information called kilometrage or track number information. Note that a method for obtaining the train position information is not limited thereto, and other conventionally known methods may be used. For example, the current position and speed of the train 2 may be detected on the basis of position information output from a global positioning system (GPS) receiver (not illustrated) provided on the train 2. Note that since the GPS receiver may be unable to receive radio waves when the train 2 goes through a tunnel or the like, the train control apparatus 5 may further include an inertia navigation system (INS). The train control apparatus 5 outputs, to the on-board wireless device 6 and the forward monitoring apparatus 3, train position information indicating the detected current position of the train 2 and train speed information indicating the detected speed of the train 2.

The on-board wireless device 6 includes an antenna for wirelessly transmitting and receiving signals to and from the ground control apparatus 43 provided on a ground side. The on-board wireless device 6 periodically transmits the train position information and the train speed information received from the train control apparatus 5 to the ground control apparatus 43 via ground wireless devices 44. In addition, the on-board wireless device 6 receives information such as train control information for controlling the traveling of the train 2 transmitted from the ground control apparatus 43 via the ground wireless devices 44, and outputs the received information to the train control apparatus 5. The train control apparatus 5 controls the traveling of the train 2 on the basis of, for example, the train control information received from the ground control apparatus 43 via the on-board wireless device 6.

For example, the output device 7 is a device for presenting, to a user such as a driver of the train 2, obstacle detection information output from the forward monitoring apparatus 3 when the forward monitoring apparatus 3 detects an obstacle requiring a collision avoidance action. Examples of the obstacle include things and persons that may hinder the traveling of the train 2, such as a fallen rock or fallen tree on or around a track, a person who has intruded into the track, and a passenger who has fallen from a platform of a station. Examples of the collision avoidance action include an action in which the driver stops the train 2 and an action in which the driver blows a whistle, so as to avoid a collision between the train 2 and an obstacle. For example, a monitor or an indicator light installed on a cab of the train 2 can be used as the output device 7, but the output device 7 is not limited thereto. The output device 7 may output the obstacle detection information output from the forward monitoring apparatus 3 as audio output via a speaker or the like, or may output the obstacle detection information as printed matter. In addition, the output device 7 may automatically apply an emergency brake when the forward monitoring apparatus 3 detects an obstacle requiring a collision avoidance action. Note that the train 2 may be a train including a plurality of cars, or may be a single-car train including one car as illustrated in FIG. 1.

As illustrated in FIG. 1, the forward monitoring apparatus 3 includes a monitoring unit 31, a storage unit 32, a train position acquisition unit 33, a route information acquisition unit 34, a monitoring direction determination unit 35, and an obstacle determination unit 36. The monitoring unit 31 is installed on a lead car of the train 2, and monitors a situation ahead of the train 2. Note that in a case where the train 2 includes a plurality of cars, the lead car is changed according to the traveling direction of the train 2, and thus the monitoring unit 31 is installed on cars at both ends. For example, in a case where the train 2 is a ten-car train including first to tenth cars, the first car or the tenth car serves as a lead car according to the traveling direction. In this case, the monitoring unit 31 is installed on the first car and the tenth car of the train 2. The forward monitoring apparatus 3 uses the monitoring unit 31 installed on a car serving as a lead car in accordance with the traveling direction of the train 2.

Various sensors capable of detecting an obstacle can be used as the monitoring unit 31. For example, a camera capable of capturing an image of a forward view from the train 2, a stereo camera, and a laser ranging device such as light detection and ranging (LIDAR) can be used as the monitoring unit 31. In addition, a single monitoring unit 31 may be provided. Alternatively, a plurality of the monitoring units 31 may be provided. For example, two or more cameras having different focal lengths may be used. Furthermore, an infrared camera may be added so as to capture images at night or in tunnels. In addition, the monitoring unit 31 may include two or more different devices, and may be configured such that, for example, a camera and a laser ranging device are combined and included in the monitoring unit 31.

The storage unit 32 stores, for example, map information including information on the position of a track on which the train 2 travels, the shape of the track, and the position of a turnout provided on the track. More specifically, the storage unit 32 stores, as map information, three-dimensional coordinate data in an x-axis direction, a y-axis direction, and a z-axis direction such as positions at prescribed intervals on a track in kilometers. Furthermore, examples of the map information include route information and linear information. The route information indicates, for example, the position of each station, the stop target position of each station, and the inclination (gradient), degree of curve (curvature radius), and the like of a track on a travel route. The linear information indicates, for example, a turnout ID for identifying each of a plurality of turnouts provided on a track, the position of each turnout, and a track diverging from or merging with another track.

For example, the train position acquisition unit 33 is an interface for acquiring information output from the train control apparatus 5. The train position acquisition unit 33 acquires train position information and train speed information output from the train control apparatus 5. The train position information indicates the current position of the train 2. The train speed information indicates the speed of the train 2. The train position acquisition unit 33 outputs the acquired train position information and train speed information to the monitoring direction determination unit 35.

For example, the route information acquisition unit 34 is an interface for acquiring, via the on-board wireless device 6, information transmitted from the ground side. The route information acquisition unit 34 acquires open route information from the ground control apparatus 43 via the ground wireless devices 44 and the on-board wireless device 6.

FIG. 2 is a diagram showing an example of the open route information. The open route information includes information for indicating an open direction of a turnout located ahead of the train 2. As illustrated in FIG. 2, the open route information includes open direction information indicating, for example, a turnout ID for identifying each turnout provided on a track on which the train 2 travels and an open direction of each turnout. FIG. 2 shows an example of the open direction information in which the open direction of each turnout is represented as a normal position or reverse position. Note that the open route information may include information other than the information illustrated in FIG. 2, and may include, for example, turnout position information indicating the position of each turnout. Furthermore, the open route information is not limited to the above. For example, the route information acquisition unit 34 may acquire, as the open route information, stop limit point information from the ground control apparatus 43 via the ground wireless devices 44 and the on-board wireless device 6. The stop limit point information indicates a limit point at which the train 2 should stop. The route information acquisition unit 34 outputs the acquired open route information to the monitoring direction determination unit 35. Note that the turnout changes the route of the train 2. The turnout is provided in such a way as to correspond to a diverging point of the track, and is operation-controlled by the gang control apparatus 42 to change and lock the route of the train 2.

The monitoring direction determination unit 35 determines a direction to be monitored by the monitoring unit 31, by using the open route information acquired by the route information acquisition unit 34, the train position information acquired by the train position acquisition unit 33, and the map information stored in the storage unit 32. The direction determined by the monitoring direction determination unit 35, which is a direction to be monitored by the monitoring unit 31, is a direction based on the traveling direction of the train 2. When the direction to be monitored by the monitoring unit 31 is determined, the monitoring direction determination unit 35 generates a monitoring direction control signal for adjusting the direction to be monitored by the monitoring unit 31 to the traveling direction of the train 2, and outputs the generated signal to the monitoring unit 31. The monitoring unit 31 adjusts the monitoring direction on the basis of the monitoring direction control signal acquired from the monitoring direction determination unit 35 such that the monitoring direction matches a direction based on the traveling direction of the train 2, and monitors a situation ahead of the train 2. The monitoring unit 31 outputs, to the obstacle determination unit 36, a monitoring result obtained as a result of the monitoring of the situation ahead of the train 2.

The obstacle determination unit 36 determines whether there is an obstacle in the traveling direction of the train 2 on the basis of the monitoring result acquired from the monitoring unit 31. For example, in a case where the monitoring unit 31 is a camera, the obstacle determination unit 36 acquires, as a monitoring result, an image of an area corresponding to a monitoring range, captured by the camera. Then, the obstacle determination unit 36 determines whether there is an obstacle in an area in the traveling direction of the train 2 by using the captured image that has been acquired. When it is determined that there is an obstacle in the area in the traveling direction of the train 2, the obstacle determination unit 36 determines whether a collision avoidance action for avoiding collision with the obstacle needs to be taken by the train 2. When determining that the collision avoidance action needs to be taken by the train 2, the obstacle determination unit 36 outputs, to the output device 7, an instruction to urge the train 2 to take a collision avoidance action together with information on the obstacle, as the obstacle detection information. The information on the obstacle is, for example, information indicating the position of the obstacle, the size of the obstacle, and the type of the obstacle, but is not particularly limited thereto. In addition, when the monitoring unit 31 is, for example, a laser ranging device, the obstacle determination unit 36 may acquire, as a monitoring result, a scanning result obtained by application of a laser to a specific object and the measuring of a distance from the forward monitoring apparatus 3 to the object, and may determine whether there is an obstacle in the area in the traveling direction of the train 2 by using the scanning result.

The operation control apparatus 41 is an apparatus that controls operation of a plurality of the trains 2 traveling on tracks. As illustrated in FIG. 1, the operation control apparatus 41 is connected to the gang control apparatus 42 and the ground control apparatus 43 via a network 8 such that the operation control apparatus 41 can intercommunicate with the gang control apparatus 42 and the ground control apparatus 43. In addition, the ground control apparatus 43 and a plurality of the ground wireless devices 44 are communicably connected to each other via a network 9. The plurality of ground wireless devices 44 is arranged along the track on which the train 2 travels. The ground wireless device 44 relays transmission and reception of information between the train control apparatus 5 installed on the train 2 and the ground control apparatus 43. The ground wireless device 44 receives, for example, a wireless signal transmitted from the train control apparatus 5 via the on-board wireless device 6, and transmits train position information included in the wireless signal to the ground control apparatus 43. In addition, the ground wireless device 44 transmits a wireless signal including train control information acquired from the ground control apparatus 43 to the train 2 located within its own wireless communication range.

The ground control apparatus 43 acquires the train position information from the train control apparatus 5 via the on-board wireless device 6 and the ground wireless devices 44, and grasps the current position of the train 2 on the basis of the acquired train position information. In addition, the ground control apparatus 43 transmits the train position information to the operation control apparatus 41 via the network 8. Furthermore, for example, the ground control apparatus 43 receives operation control information on the train 2 from the operation control apparatus 41, and transmits the received operation control information to the train 2 via the network 9.

The gang control apparatus 42 controls operation of a turnout on the basis of the control information output from the operation control apparatus 41 to form a route of the train 2. In addition, the gang control apparatus 42 grasps the state of each turnout operation-controlled by the gang control apparatus 42, and transmits, to the ground control apparatus 43, open route information including open direction information indicating each turnout ID and the open direction of each turnout. Then, the ground control apparatus 43 transmits the open route information to the forward monitoring apparatus 3 via the ground wireless devices 44 and the on-board wireless device 6. Note that, for example, the ground control apparatus 43 may transmit, as the open route information, each piece of train position information and stop limit point information to the forward monitoring apparatus 3. Each piece of train position information is acquired from the train control apparatus 5 on the train through wireless communication. The stop limit point information is calculated on the basis of the state of a turnout, and the like. The stop limit point information is information indicating a stop limit point at which the train 2 should stop, that is, information indicating a stop limit point that is a point through which the train 2 can travel. In addition, while an example has been described in which the ground control apparatus 43 transmits open route information to the train 2 through wireless communication in the train control system 1 according to the present embodiment, the train control system 1 may be configured such that the open route information is transmitted from the operation control apparatus 41 to the train 2 through wireless communication.

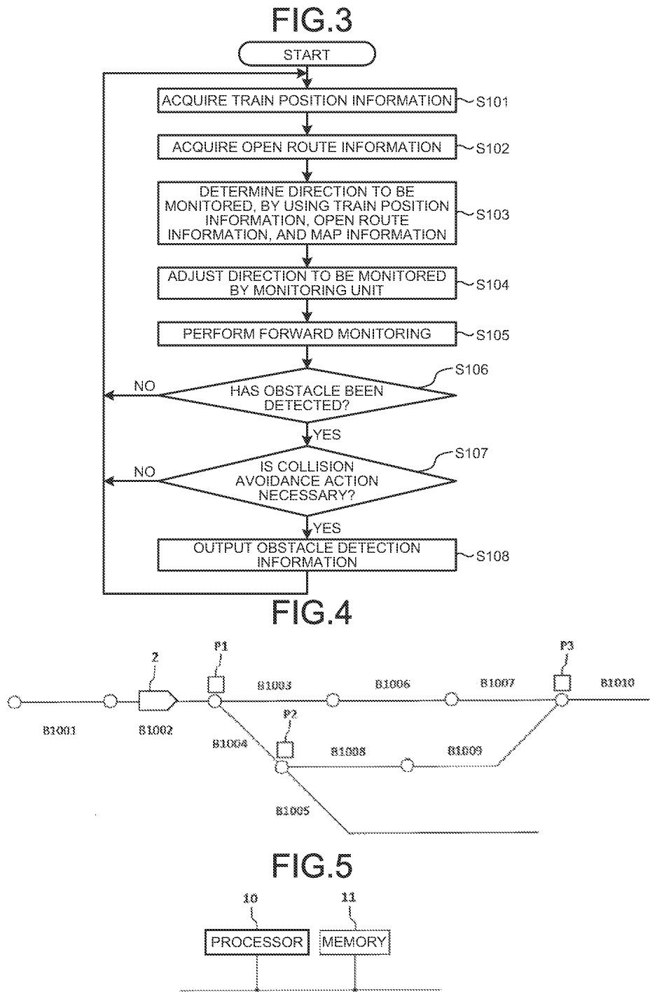

FIG. 3 is a flowchart showing an example of a flow of forward monitoring processing to be performed by the forward monitoring apparatus 3 according to the first embodiment of the present disclosure. Hereinafter, an example of the flow of forward monitoring processing to be performed by the forward monitoring apparatus 3 according to the first embodiment of the present disclosure will be described with reference to the flowchart of FIG. 3. As illustrated in FIG. 3, in step S101, the forward monitoring apparatus 3 acquires, by means of the train position acquisition unit 33, train position information and train speed information respectively indicating the current position of the train 2 and the speed of the train 2 detected by the train control apparatus 5.

In step S102, the forward monitoring apparatus 3 acquires, by means of the route information acquisition unit 34, open route information from the ground control apparatus 43 via the ground wireless devices 44 and the on-board wireless device 6. The open route information includes information for indicating the open direction of a turnout located ahead of the train 2. Note that FIG. 3 shows an example in which the forward monitoring apparatus 3 acquires the train position information and the train speed information by means of the train position acquisition unit 33 in step S101, and acquires the open route information by means of the route information acquisition unit 34 in step S102. However, the processing in steps S101 and S102 need not be performed in this order, and may be performed in reverse order or simultaneously. Furthermore, the forward monitoring apparatus 3 may be configured such that the route information acquisition unit 34 acquires the open route information not from the on-board wireless device 6 but via the train control apparatus 5.

Next, in step S103, the forward monitoring apparatus 3 causes the monitoring direction determination unit 35 to determine a direction to be monitored by the monitoring unit 31, by using the open route information acquired by the route information acquisition unit 34, the train position information acquired by the train position acquisition unit 33, and the map information stored in the storage unit 32.

FIG. 4 is a diagram for describing an example of processing to be performed by the forward monitoring apparatus 3 according to the first embodiment of the present disclosure, for determining a direction to be monitored by the monitoring unit 31. In FIGS. 4, B1001 to B1010 represent block numbers uniquely assigned to a plurality of divided blocks on a track. Note that the starting points and ending points of the blocks B1001 to B1010 are indicated by open circles. In addition, three turnouts P1 to P3 are provided on tracks illustrated in FIG. 4. FIG. 4 shows an example in which the turnout P1 is located at the ending point of the block B1002, the turnout P2 is located at the ending point of the block B1004, and the turnout P3 is located at the ending points of the block B1007 and the block B1009. For example, when the train 2 travels on a track provided with a plurality of turnouts as illustrated in FIG. 4, the monitoring direction determination unit 35 recognizes the traveling direction of the train 2 by collating the open route information and the train position information with the map information, and determines a direction to be monitored by the monitoring unit 31 on the basis of the traveling direction of the train 2. For example, as illustrated in FIG. 2, the open route information includes open direction information indicating a turnout ID for identifying each of a plurality of turnouts provided on a track on which the train 2 travels and the open direction of each turnout. In addition, the map information includes information on the position of the track, the shape of the track, and the position of each turnout provided on the track. The monitoring direction determination unit 35 can recognize the position and open direction of a turnout corresponding to each turnout ID by collating, with the map information, the turnout ID included in the open route information acquired by the route information acquisition unit 34. In addition, the monitoring direction determination unit 35 can recognize where the train 2 is located on the track by collating the current position of the train 2 indicated by the train position information with the map information. As a result, the monitoring direction determination unit 35 can recognize the traveling direction of the train 2 from the current position of the train 2, the position of the turnout located ahead of the train 2, and the open direction of the turnout. Then, the monitoring direction determination unit 35 determines a direction to be monitored by the monitoring unit 31 on the basis of the traveling direction of the train 2. In addition, the monitoring direction determination unit 35 generates a monitoring direction control signal for adjusting the direction to be monitored by the monitoring unit 31 to the traveling direction of the train 2, and outputs the generated signal to the monitoring unit 31.

In step S104, based on the monitoring direction control signal output from the monitoring direction determination unit 35, the monitoring unit 31 adjusts the direction to be monitored by itself to the traveling direction of the train 2. As a result, the forward monitoring apparatus 3 can appropriately recognize a direction in which the train 2 will travel after the track diverges, in advance of arrival of the train 2 at a point located before each turnout, so that the direction to be monitored by the monitoring unit 31 can be adjusted to the traveling direction of the train 2. For example, in a case where the train 2 is located in the block B1002 located before the turnout P1 as illustrated in FIG. 4, when the train 2 travels in the direction of the block B1004, that is, when a route is changed by the turnout P1, the forward monitoring apparatus 3 adjusts the direction to be monitored by the monitoring unit 31 to the shape of the track of the block B1004 located ahead of the turnout P1.

Next, in step S105, the forward monitoring apparatus 3 monitors a situation ahead of the train 2 by means of the monitoring unit 31. For example, in a case where the monitoring unit 31 is a camera, the forward monitoring apparatus 3 acquires, as a monitoring result, an image of an area corresponding to a monitoring range, captured by the camera, and outputs the acquired image to the obstacle determination unit 36. Note that when the monitoring unit 31 is a laser ranging device, the forward monitoring apparatus 3 just needs to acquire, as a monitoring result, a scanning result obtained by application of a laser to a specific object and the measuring of a distance from the forward monitoring apparatus 3 to the object, and output the scanning result to the obstacle determination unit 36.

In step S106, when a captured image is input as a monitoring result, the obstacle determination unit 36 uses the captured image to determine whether there is an obstacle in an area in the traveling direction of the train 2. In step S106, when no obstacle is detected in the captured image (No), the obstacle determination unit 36 returns to step S101, and performs the same processing as described above. In step S106, when an obstacle is detected in the captured image (Yes), the obstacle determination unit 36 determines in step S107 whether a collision avoidance action for avoiding collision with the obstacle needs to be taken by the train 2, on the basis of the captured image.

When it is determined on the basis of the captured image that the detected obstacle is, for example, a bird or a small animal, the obstacle determination unit 36 determines in step S107 that the collision avoidance action is not necessary (No) in view of the behavior of birds, small animals, or the like escaping from the monitoring area as the train 2 moves forward, and returns to step S101 to perform the same operation as described above. When it is determined on the basis of the captured image that the detected obstacle is, for example, a fallen rock, a fallen tree, or a person who has intruded into the track, the obstacle determination unit 36 determines in step S107 that the collision avoidance action is necessary (Yes), and outputs, to the output device 7, an instruction or the like to urge the train 2 to take a collision avoidance action together with information on the obstacle, as obstacle detection information from the obstacle determination unit 36 in step S108.

Note that while an example has been described in which processing is performed by the obstacle determination unit 36 by use of a captured image as a monitoring result in step S106 and the subsequent steps, a scanning result obtained by a laser ranging device or both a captured image and a scanning result may be used as the monitoring result. In addition, in a case where the forward monitoring apparatus 3 includes both a camera and a laser ranging device as the monitoring unit 31, when it is difficult to detect an obstacle on the basis of a captured image in a situation where, for example, visibility is poor at night or in bad weather such as rain or fog, priority may be given to monitoring performed by the laser ranging device. In addition, in a case where the forward monitoring apparatus 3 includes a plurality of the monitoring units 31, the forward monitoring apparatus 3 may adjust a direction to be monitored by at least one of the monitoring units 31 to the traveling direction of the train 2, and a direction to be monitored by another monitoring unit 31 may be adjusted such that the another monitoring unit 31 monitors an area in a direction opposite to the traveling direction of the train 2, the area being adjusted to the front direction or traveling direction of the train 2. Furthermore, the forward monitoring apparatus 3 may change the area to be monitored by the monitoring unit 31, by also using the train speed information.

Next, a hardware configuration of the forward monitoring apparatus 3 will be described. In the forward monitoring apparatus 3, the storage unit 32 is a memory. The monitoring unit 31 is a sensor. In the forward monitoring apparatus 3, the other constituent elements are implemented by processing circuitry. The processing circuitry may be a memory and a processor that executes programs stored in the memory, or may be dedicated hardware.

FIG. 5 is a diagram showing an example in which processing circuitry included in the forward monitoring apparatus 3 according to the first embodiment of the present disclosure includes a processor and a memory. In a case where the processing circuitry includes a processor 10 and a memory 11, each function of the processing circuitry of the forward monitoring apparatus 3 is implemented by software, firmware, or a combination of software and firmware. The software or firmware is described as a program, and stored in the memory 11. The processor 10 reads and executes the program stored in the memory 11 to implement each function of the processing circuitry. That is, the processing circuitry includes the memory 11 for storing programs. As a result of execution of the programs, the forward monitoring apparatus 3 is caused to perform processing. In addition, it can also be said that these programs cause a computer to execute a procedure and a method for the forward monitoring apparatus 3.

Here, the processor 10 may be a central processing unit (CPU), a processing device, an arithmetic device, a microprocessor, a microcomputer, a digital signal processor (DSP), or the like. Furthermore, for example, a nonvolatile or volatile semiconductor memory such as a random access memory (RAM), a read only memory (ROM), a flash memory, an erasable programmable ROM (EPROM), or an electrically EPROM (EEPROM) (registered trademark), a magnetic disk, a flexible disk, an optical disk, a compact disk, a mini disk, or a digital versatile disc (DVD) is applicable to the memory 11.

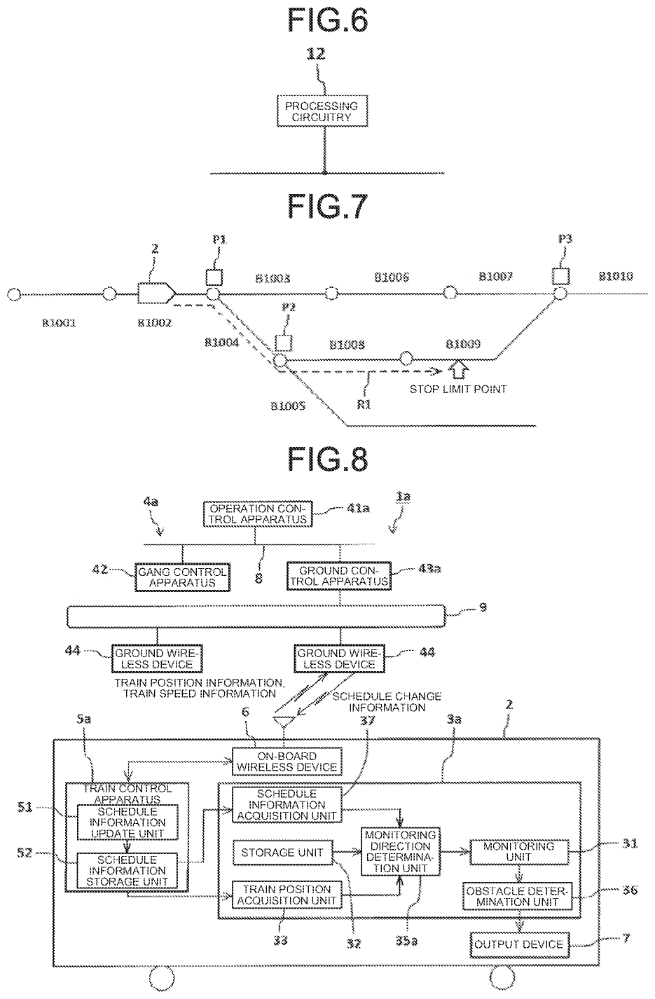

FIG. 6 is a diagram showing an example in which the processing circuitry included in the forward monitoring apparatus 3 according to the first embodiment of the present disclosure includes dedicated hardware. In a case where processing circuitry 12 includes dedicated hardware, for example, a single circuit, a composite circuit, a programmed processor, a parallel-programmed processor, an application specific integrated circuit (ASIC), a field programmable gate array (FPGA), or a combination thereof is applicable to the processing circuitry 12 illustrated in FIG. 6. The functions of the forward monitoring apparatus 3 may be separately implemented by the processing circuitry 12, or may be collectively implemented by the processing circuitry 12. Note that some of the functions of the forward monitoring apparatus 3 may be implemented by dedicated hardware, and some of the other functions thereof may be implemented by software or firmware. Thus, the processing circuitry 12 can implement each of the above-described functions by means of dedicated hardware, software, firmware, or a combination thereof.

The forward monitoring apparatus 3 according to the first embodiment of the present disclosure is installed on the train 2, and includes: the monitoring unit 31 that monitors a situation ahead of the train 2; the storage unit 32 that stores map information including information on a position of a track on which the train 2 travels, a shape of the track, and a position of a turnout provided on the track; the train position acquisition unit 33 that acquires train position information indicating a position of the train 2; the route information acquisition unit 34 that acquires open route information including information for indicating an open direction of the turnout located ahead of the train 2; and the monitoring direction determination unit 35 that determines a direction to be monitored by the monitoring unit 31, by using the open route information, the train position information, and the map information, the open route information being acquired by the route information acquisition unit 34, the train position information being acquired by the train position acquisition unit 33, the map information being stored in the storage unit 32. Therefore, it is possible to appropriately recognize a traveling direction in which the train 2 should go after passing through a turnout, and adjust a direction to be monitored to the traveling direction of the train 2 even on a track on which a plurality of turnouts is consecutively provided.

In the forward monitoring apparatus 3 according to the first embodiment of the present disclosure, the route information acquisition unit 34 acquires the open route information transmitted from the ground side via the on-board wireless device 6 installed on the train 2. Therefore, even when a plurality of turnouts is consecutively provided, it is also possible to recognize the open directions of a plurality of turnouts located ahead. As a result, in a case where a plurality of turnouts is consecutively provided, the forward monitoring apparatus 3 can adjust a direction to be monitored by the monitoring unit 31 also in consideration of the open directions of the plurality of turnouts located ahead.

In addition, an example has been described in which information including open direction information indicating a turnout ID for identifying each of a plurality of turnouts provided on a track and the open direction of each turnout is used as open route information in the above-described forward monitoring apparatus 3 according to the first embodiment of the present disclosure. However, the forward monitoring apparatus 3 may use, as the open route information, stop limit point information acquired from the ground control apparatus 43 via the ground wireless devices 44 and the on-board wireless device 6. In addition, route information represented as an arrangement of blocks illustrated in FIG. 4 may be used as the open route information.

FIG. 7 is a diagram for describing another example of the processing to be performed by the forward monitoring apparatus 3 according to the first embodiment of the present disclosure, for determining a direction to be monitored by the monitoring unit 31. FIG. 7 shows an example in which a stop limit point that is a point through which the train 2 can travel is set in the block B1009. In this case, in step S102 of the flowchart illustrated in FIG. 3, the route information acquisition unit 34 of the forward monitoring apparatus 3 acquires stop limit point information as open route information from the ground control apparatus 43 through wireless communication, and outputs the stop limit point information to the monitoring direction determination unit 35.

Then, in step S103 of the flowchart illustrated in FIG. 3, the monitoring direction determination unit 35 recognizes the traveling direction of the train 2 by collating the stop limit point information (open route information) and the train position information with the map information, and determines a direction to be monitored by the monitoring unit 31 on the basis of the traveling direction of the train 2. Specifically, the monitoring direction determination unit 35 can recognize that the train 2 can travel to the position of the stop limit point illustrated in FIG. 7 by collating the stop limit point information acquired from the route information acquisition unit 34 with the map information. In addition, the monitoring direction determination unit 35 can recognize where the train 2 is located on the track by collating the current position of the train 2 indicated by the train position information acquired from the train position acquisition unit 33 with the map information. As a result, the monitoring direction determination unit 35 can recognize a travel route R1 indicated by a dashed arrow in FIG. 7 from the current position of the train 2 to the stop limit point that is a point through which the train 2 can travel, and thus can recognize the traveling direction of the train 2 at the current position of the train 2. Then, the monitoring direction determination unit 35 determines a direction to be monitored by the monitoring unit 31 on the basis of the traveling direction of the train 2. In addition, the monitoring direction determination unit 35 generates a monitoring direction control signal for adjusting the direction to be monitored by the monitoring unit 31 to the traveling direction of the train 2, and outputs the generated signal to the monitoring unit 31. Note that subsequently, processing is performed which is the same as the processing in step S104 and the subsequent steps of the flowchart illustrated in FIG. 3, and description thereof is thus omitted.

According to the forward monitoring apparatus 3 of the first embodiment of the present disclosure, since the open route information includes the stop limit point information indicating the limit point at which the train 2 should stop, it is possible to adjust the direction to be monitored by the monitoring unit 31 to the traveling direction of the train 2 by using information received through communications based train control (CBTC) or the like.

Furthermore, for example, the forward monitoring apparatus 3 may use, as the open route information, stop track circuit information included in an ATC message used in a single-stage pattern ATC system (hereinafter, referred to as a single-stage ATC). Although not illustrated in detail, in the case of a single-stage ATC, an ATC message is transmitted from the ground side to the train 2 through rails on which the train 2 travels. The stop track circuit information indicates a train and a track circuit ID to be stopped, and a track circuit (stop track circuit) of the entry limit for a following train is determined by, for example, a track circuit where the end of the preceding train is located. Therefore, the train 2 just needs to be equipped with an ATC receiver for receiving an ATC message including stop track circuit information so that the route information acquisition unit 34 of the forward monitoring apparatus 3 can acquire stop track circuit information received by the ATC receiver as open route information, and output the stop track circuit information to the monitoring direction determination unit 35.

Then, in step S103 of the flowchart illustrated in FIG. 3, the monitoring direction determination unit 35 recognizes the traveling direction of the train 2 by collating the stop track circuit information (open route information) and the train position information with the map information, and determines a direction to be monitored by the monitoring unit 31 on the basis of the traveling direction of the train 2. Specifically, the monitoring direction determination unit 35 can recognize a track circuit of the entry limit of the train 2 by collating the stop track circuit information acquired from the route information acquisition unit 34 with the map information. In addition, the monitoring direction determination unit 35 can recognize where the train 2 is located on the track by collating the current position of the train 2 indicated by the train position information acquired from the train position acquisition unit 33 with the map information. As a result, since the monitoring direction determination unit 35 can recognize a travel route from the current position of the train 2 to a track circuit through which the train 2 can travel, it is possible to recognize the traveling direction of the train 2 at the current position of the train 2. Then, the monitoring direction determination unit 35 determines a direction to be monitored by the monitoring unit 31 on the basis of the traveling direction of the train 2. In addition, the monitoring direction determination unit 35 generates a monitoring direction control signal for adjusting the direction to be monitored by the monitoring unit 31 to the traveling direction of the train 2, and outputs the generated signal to the monitoring unit 31. Note that subsequently, processing is performed which is the same as the processing in step S104 and the subsequent steps of the flowchart illustrated in FIG. 3, and description thereof is thus omitted.

Note that, in Patent Literature 1 (Japanese Patent Application Laid-open No. 2019-004587), since it is necessary to give information on the traveling direction of a train, which is different from information to be transmitted in a normal ATC loop, a process of separately generating the information on the traveling direction of the train is newly required on the ground side. That is, a process for newly adding information on the traveling direction of the train at a diverging point is required in the ATC system of Patent Literature 1.

Meanwhile, use of stop track circuit information included in an ATC message that is usually used in a single-stage ATC, as open route information as described above allows the forward monitoring apparatus 3 to adjust a direction to be monitored by the monitoring unit 31 to the traveling direction of the train 2 without providing new processing or an additional installation on the ground side.

### Second Embodiment

Next, a train control system according to a second embodiment of the present disclosure will be described. FIG. 8 is a block diagram showing an example of a configuration of a train control system according to the present embodiment, that is, the second embodiment. Note that the same constituent elements and the like as those of the train control system 1 according to the first embodiment of the present disclosure are denoted by the same reference numerals, and a detailed description thereof will be omitted. As illustrated in FIG. 8, in a train control system 1a according to the second embodiment, a ground control apparatus 43a of an operation control system 4a is configured to acquire schedule change information from an operation control apparatus 41a, and transmit the schedule change information to a train control apparatus 5a of the train 2 via the ground wireless devices 44 and the on-board wireless device 6 when the schedule of the train 2 is changed by the operation control apparatus 41a.

Although not illustrated in detail, the operation control apparatus 41a includes a schedule database that stores schedule information. The schedule information includes, for example, information such as the train number and train car type of each train scheduled to travel on a track, a distinction as to whether the train is an up train or down train, the travel section of the train, the arrival time and departure time of the train at each station, and a track number of a track to be used by the train on a travel route. When there is a schedule change, the operation control apparatus 41a generates schedule change information including information on the schedule change, updates schedule information stored in the schedule database with the schedule change information, and transmits the schedule change information to the ground control apparatus 43a. When acquiring the schedule change information from the operation control apparatus 41a, the ground control apparatus 43a transmits the schedule change information to the train control apparatus 5a of the train 2 via the ground wireless devices 44 and the on-board wireless device 6. Note that the schedule change information is information corresponding to schedule information updated in such a way as to reflect details of the schedule change, and includes information such as the train number and train car type of each train scheduled to travel on a track, a distinction as to whether the train is an up train or down train, the travel section of the train, the arrival time and departure time of the train at each station, and a track number of a track to be used by the train on a travel route, as with the schedule information.

The train control apparatus 5a includes a schedule information update unit 51 and a schedule information storage unit 52. When schedule change information is acquired from the ground control apparatus 43a via the ground wireless devices 44 and the on-board wireless device 6, the schedule information update unit 51 updates schedule information stored in advance in the schedule information storage unit 52 with the schedule change information. The schedule information storage unit 52 stores in advance schedule information indicating a pre-change operation schedule. When schedule information is updated with schedule change information by the schedule information update unit 51, the schedule information storage unit 52 stores the schedule change information as new schedule information.

A forward monitoring apparatus 3a includes a schedule information acquisition unit 37 instead of the route information acquisition unit 34 of the forward monitoring apparatus 3 according to the first embodiment. The schedule information acquisition unit 37 acquires schedule information from the schedule information storage unit 52 of the train control apparatus 5a. When schedule information stored in the schedule information storage unit 52 is changed to schedule change information by the schedule information update unit 51, the schedule information acquisition unit 37 acquires the schedule change information from the schedule information storage unit 52 as new schedule information, and outputs the schedule change information to a monitoring direction determination unit 35a. The monitoring direction determination unit 35a determines a direction to be monitored by the monitoring unit 31 by using the schedule information acquired by the schedule information acquisition unit 37, train position information acquired by the train position acquisition unit 33, and map information stored in the storage unit 32.

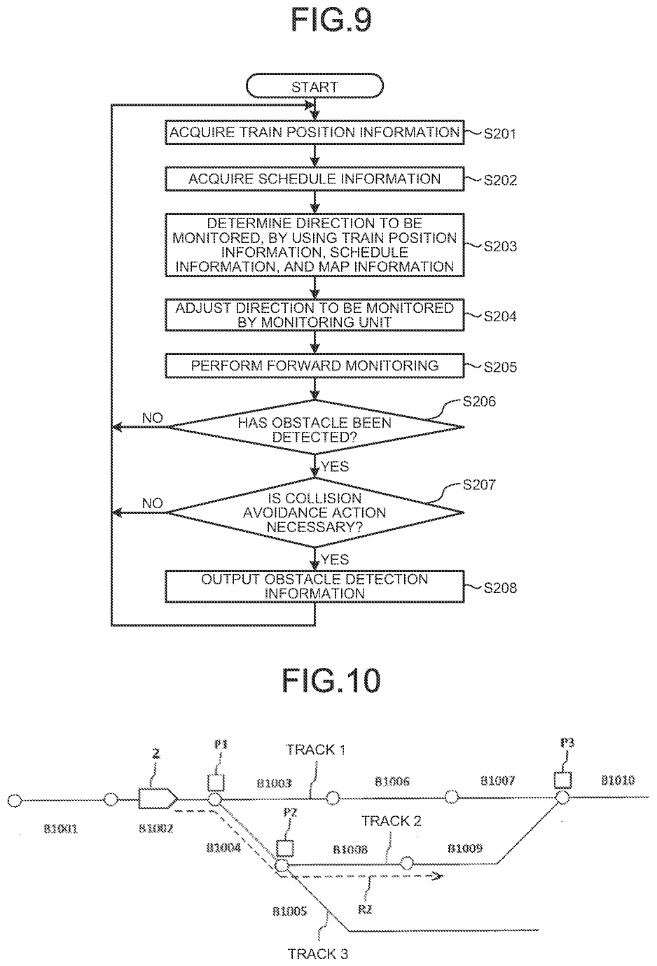

FIG. 9 is a flowchart showing an example of a flow of forward monitoring processing to be performed by the forward monitoring apparatus 3a according to the second embodiment of the present disclosure. Hereinafter, an example of the flow of forward monitoring processing to be performed by the forward monitoring apparatus 3a according to the second embodiment of the present disclosure will be described with reference to the flowchart of FIG. 9. As illustrated in FIG. 9, in step S201, the forward monitoring apparatus 3a acquires, by means of the train position acquisition unit 33, train position information and train speed information respectively indicating the current position of the train 2 and the speed of the train 2 detected by the train control apparatus 5.

In step S202, the forward monitoring apparatus 3a acquires, by means of the schedule information acquisition unit 37, schedule information including information on the track number of a track to be used by the train 2 from the schedule information storage unit 52. Note that when the schedule of the train 2 is changed by the operation control apparatus 41a on the ground side, schedule information stored in the schedule information storage unit 52 is updated with schedule change information by the schedule information update unit 51 as described above. Therefore, when the operation control apparatus 41a changes the schedule of the train 2, the schedule information acquisition unit 37 acquires the schedule change information as new schedule information from the schedule information storage unit 52. In addition, while FIG. 9 shows an example in which the forward monitoring apparatus 3a acquires the train position information and the train speed information by means of the train position acquisition unit 33 in step S201, and acquires the schedule information by means of the schedule information acquisition unit 37 in step S202, the processing in steps S201 and S202 need not be performed in this order, and may be performed in reverse order or simultaneously.

Next, in step S203, the forward monitoring apparatus 3a causes the monitoring direction determination unit 35 to determine a direction to be monitored by the monitoring unit 31, by using the schedule information acquired by the schedule information acquisition unit 37, the train position information acquired by the train position acquisition unit 33, and the map information stored in the storage unit 32.

FIG. 10 is a diagram for describing an example of processing to be performed by the forward monitoring apparatus 3a according to the second embodiment of the present disclosure, for determining a direction to be monitored by the monitoring unit 31. FIG. 10 shows an example in which the block B1003 corresponds to track 1, the block B1008 corresponds to track 2, and the block B1005 corresponds to track 3. When schedule information acquired from the schedule information acquisition unit 37 includes information indicating that a track to be used by the train 2 is, for example, track 2, the monitoring direction determination unit 35a can recognize that the train 2 travels on track 2 (a route including the block B1008) in FIG. 10 by collating the schedule information with the map information. In addition, the monitoring direction determination unit 35a can recognize where the train 2 is located on the track by collating the current position of the train 2 indicated by the train position information acquired from the train position acquisition unit 33 with the map information. As a result, since the monitoring direction determination unit 35a can recognize that the train 2 travels on a travel route R2 indicated by a dashed arrow in FIG. 10 on the basis of information on the current position of the train 2 on the track and the track number of a track to be used by the train 2, that is, track 2 on which the train 2 travels, it is possible to recognize the traveling direction of the train 2 at the current position of the train 2. Then, the monitoring direction determination unit 35a determines a direction to be monitored by the monitoring unit 31 on the basis of the traveling direction of the train 2. In addition, the monitoring direction determination unit 35a generates a monitoring direction control signal for adjusting the direction to be monitored by the monitoring unit 31 to the traveling direction of the train 2, and outputs the generated signal to the monitoring unit 31. Note that the processing in steps S204 to S208 of the flowchart illustrated in FIG. 9 is the same as the processing in steps S104 to S108 of the flowchart illustrated in FIG. 3, respectively, and description thereof is thus omitted.

Note that while an example has been described above in which the ground control apparatus 43a transmits the schedule change information to the train 2 through wireless communication in the train control system 1a according to the present embodiment, that is, the second embodiment, the train control system 1a may be configured such that the schedule change information is transmitted from the operation control apparatus 41a to the train 2 through wireless communication. In addition, while an example has been described above in which the train control apparatus includes the schedule information update unit and the schedule information storage unit in the train control system 1a according to the present embodiment, that is, the second embodiment, the train control system 1a may be configured such that the schedule information update unit and the schedule information storage unit are included in the forward monitoring apparatus.

The forward monitoring apparatus 3a according to the second embodiment of the present disclosure is installed on the train 2, and includes: the monitoring unit 31 that monitors a situation ahead of the train 2; the storage unit 32 that stores map information including information on a position of a track on which the train 2 travels, a shape of the track, and a position of a turnout provided on the track; the train position acquisition unit 33 that acquires train position information indicating a position of the train 2; the schedule information acquisition unit 37 that acquires schedule information including information on a track number of a track to be used by the train 2; and the monitoring direction determination unit 35a that determines a direction to be monitored by the monitoring unit 31, by using the schedule information, the train position information, and the map information, the schedule information being acquired by the schedule information acquisition unit 37, the train position information being acquired by the train position acquisition unit 33, the map information being stored in the storage unit 32. Therefore, it is possible to appropriately recognize a traveling direction in which the train 2 should go after passing through a turnout, and adjust a direction to be monitored to the traveling direction of the train 2 even on a track on which a plurality of turnouts is consecutively provided.

Furthermore, in the forward monitoring apparatus 3a according to the second embodiment of the present disclosure, the schedule information acquisition unit 37 acquires schedule change information including information on a schedule change when the schedule of the train 2 is changed by the operation control apparatus 41a, and the monitoring direction determination unit 35a determines a direction to be monitored by the monitoring unit 31, by using the schedule change information acquired by the schedule information acquisition unit 37, the train position information acquired by the train position acquisition unit 33, and the map information stored in the storage unit 32. Therefore, even when there is a sudden route change or the like due to the schedule change, the traveling direction of the train 2 can be appropriately recognized, and the direction to be monitored can be adjusted to the traveling direction of the train 2.

In addition, the present disclosure is not limited to the above embodiments, and each embodiment can be appropriately changed or omitted without departing from the scope of the idea of the present disclosure.

### REFERENCE SIGNS LIST

1 to 1a train control system; 2 train; 3 to 3a forward monitoring apparatus; 4 to 4a operation control system; 31 monitoring unit; 32 storage unit; 33 train position acquisition unit; 34 route information acquisition unit; 35 monitoring direction determination unit; 41 operation control apparatus; P1 to P3 turnout.

1. A forward monitoring apparatus to be installed on a train, the apparatus comprising:
a monitoring circuitry to monitor a situation ahead of the train;
a storage circuitry to store map information including information on a position of a track on which the train travels, a shape of the track, and a position of a turnout provided on the track;
a train position acquisition circuitry to acquire train position information indicating a position of the train;
a route information acquisition circuitry to acquire open route information including information for indicating an open direction of the turnout located ahead of the train; and
a monitoring direction determination circuitry to determine a direction to be monitored by the monitoring circuitry, by using the open route information, the train position information, and the map information, the open route information being acquired by the route information acquisition circuitry, the train position information being acquired by the train position acquisition circuitry, the map information being stored in the storage circuitry.

2. The forward monitoring apparatus according to claim 1, wherein the route information acquisition circuitry acquires the open route information via an on-board wireless device installed on the train, the open route information being transmitted from a ground side.

3. The forward monitoring apparatus according to claim 1, wherein the open route information includes stop limit point information indicating a limit point at which the train should stop.

4. A train control system comprising: the forward monitoring apparatus according to claim 1; and an operation control system to transmit the open route information to the forward monitoring apparatus.

5. A forward monitoring apparatus to be installed on a train, the apparatus comprising:
a monitoring circuitry to monitor a situation ahead of the train;
a storage circuitry to store map information including information on a position of a track on which the train travels, a shape of the track, and a position of a turnout provided on the track;
a train position acquisition circuitry to acquire train position information indicating a position of the train;
a schedule information acquisition circuitry to acquire schedule information including information on a track number of a track to be used by the train; and
a monitoring direction determination circuitry to determine a direction to be monitored by the monitoring circuitry, by using the schedule information, the train position information, and the map information, the schedule information being acquired by the schedule information acquisition circuitry, the train position information being acquired by the train position acquisition circuitry, the map information being stored in the storage circuitry.

6. The forward monitoring apparatus according to claim 5, wherein
when an operation control apparatus makes a schedule change for the train, the schedule information acquisition circuitry acquires schedule change information including information on the schedule change, and
the monitoring direction determination circuitry determines a direction to be monitored by the monitoring circuitry, by using the schedule change information, the train position information, and the map information, the schedule change information being acquired by the schedule information acquisition circuitry, the train position information being acquired by the train position acquisition circuitry, the map information being stored in the storage circuitry.

7. A train control system comprising: the forward monitoring apparatus according to claim 5; and an operation control system to transmit the schedule information or schedule change information to the forward monitoring apparatus.

8. A forward monitoring method to be performed by a forward monitoring apparatus installed on a train, the forward monitoring apparatus including a monitoring circuitry to monitor a situation ahead of the train, the method comprising:
acquiring train position information indicating a position of the train;
acquiring open route information including information for indicating an open direction of a turnout located ahead of the train; and
determining a direction to be monitored by the monitoring circuitry, by using the open route information acquired, the train position information acquired, and map information, the map information including information on a position of a track on which the train travels, a shape of the track, and a position of the turnout provided on the track.

9. The forward monitoring method according to claim 8, wherein in acquiring the open route information, the open route information transmitted from a ground side is acquired via an on-board wireless device installed on the train.

10. The forward monitoring method according to claim 8, wherein the open route information includes stop limit point information indicating a limit point at which the train should stop.

11. (canceled)

12. (canceled)

13. The forward monitoring apparatus according to claim 2, wherein the open route information includes stop limit point information indicating a limit point at which the train should stop.

14. A train control system comprising: the forward monitoring apparatus according to claim 2; and an operation control system to transmit the open route information to the forward monitoring apparatus.

15. A train control system comprising: the forward monitoring apparatus according to claim 3; and an operation control system to transmit the open route information to the forward monitoring apparatus.

16. A train control system comprising: the forward monitoring apparatus according to claim 13; and an operation control system to transmit the open route information to the forward monitoring apparatus.

17. A train control system comprising: the forward monitoring apparatus according to claim 6; and an operation control system to transmit the schedule information or schedule change information to the forward monitoring apparatus.

18. The forward monitoring method according to claim 9, wherein the open route information includes stop limit point information indicating a limit point at which the train should stop.
